(19) United States
(12) Patent Application Publication
(10) Pub. No.: US 2015/0009663 A1
(43) Pub. Date: Jan. 8, 2015

(54) LED LAMP TUBE WITH UNIFORM LUMINANCE

(71) Applicant: BEIJING INNOTECH ENERGY TECHNOLOGY CO., LTD., Beijing (CN)

(72) Inventors: Jiansheng Ye, Shenzhen Guangdong (CN); Wei Zhu, Baoan, Shenzhen, Guangdong (CN); Changqing Li, Baoan, Shenzhen, Guangdong (CN); Chuanfu Li, Baoan, Shenzhen, Guangdong (CN)

(21) Appl. No.: 14/240,128

(22) PCT Filed: Mar. 8, 2013
(86) PCT No.: PCT/CN2013/072342

§ 371 Date: Feb. 21, 2014

(30) Foreign Application Priority Data
Mar. 9, 2012 (CN) 201210060819.8

(51) Int. Cl. F21K 99/00

(52) U.S. Cl. CPC F21K 9/175; F21Y 2103/003
USPC 362/218

(57) ABSTRACT

The present invention relates to an LED lamp tube with uniform luminance. The LED lamp tube with uniform luminance provided by the present invention comprises a lamp tube main body and a lamp holder connected to two ends of the lamp tube main body. A power supply is provided between the lamp tube main body and the lamp holder. The lamp tube main body comprises a light diffusion cover and a heat-dissipation casing engaged with each other to form a lamp cavity. A substrate with light emitting diodes provided thereon is disposed on the heat-dissipation casing. The maximum distance from the light emitting diodes to the light diffusion cover is larger than 50% of the total height of the lamp tube main body.

### FIELD OF THE INVENTION

The present invention relates to lighting devices, particularly to an LED lamp tube with uniform luminance in lighting devices.

### BACKGROUND OF THE INVENTION

LED (short for Light Emitting Diode) lamp tubes are also known as light tubes or daylight lamp tubes in which LEDs are used as the luminophor. Conventional daylight lamp tubes are also known as fluorescent lamps, two ends of which are provided with a filament, respectively; a trace amount of argon and rare mercury vapor are filled inside a daylight lamp tube; and, the inner wall of the daylight lamp tube is coated with fluorescent powder, and the gas between the two filaments emits ultraviolet rays in the case of electrical conduction, so that the fluorescent powder emits visible light. As there is heavy metal pollutant “mercury”, the environmental pollution caused by the scrapped fluorescent lamp tubes is extremely serious. In contrast, by employing light emitting diodes as the light source, LED light tubes have higher luminous efficiency, better energy saving effect and longer service life; furthermore, the LED light tubes are more environmentally friendly, thus become the most ideal product to replace the fluorescent lamp tubes at present.

As shown in FIG. 1, an exiting LED lamp tube comprises a light diffusion cover 1, a substrate 3, light emitting diodes 4 and a heat-dissipation casing 2, wherein the substrate 3 is generally an aluminum substrate (or a glass fiber cloth substrate, etc.), while the heat-dissipation casing 2 is an aluminum heat-dissipation casing. The aluminum substrate is disposed on the top of the aluminum heat-dissipation casing. The light emitting diodes 4 are disposed on the top of the aluminum substrate. Light emitted by the light emitting diodes 4 is transmitted out through the light diffusion cover 1 to realize lighting. The aluminum heat-dissipation casing is provided with an accommodation space 21 for mounting a power supply and allowing a power lead to pass through.

As shown in FIG. 2, the dotted lines with arrows in FIG. 2 represent light emitted by the light emitting diodes 4, and H1, H2 and H3 refer to the maximum distance from the light emitting diodes 4 to the light diffusion cover 1 respectively when the substrate 3 is in different height, wherein, H3>H2>H1. From FIG. 2, it can be found that the accommodation space 21 will increase the height of the top of the aluminum heat-dissipation casing although it solves the problem of mounting a power supply and threading, so that the aluminum substrate is lifted in height, the distance from the light emitting diodes 4 to the light diffusion cover 1 is thus shortened, and the overlap range of lighting between adjacent light emitting diodes 4 is reduced. As a result, non-uniform illumination of the LED lamp tube and even dark spots will occur.

As shown in FIG. 3, the dotted lines with arrows in FIG. 3 represent light emitted by the light emitting diodes 4. At present, to overcome the defect that the overlap range of lighting between adjacent light emitting diodes 4 is reduced as the distance from the light emitting diodes 4 to the light diffusion cover 1 is shortened, that is, to overcome the defects of non-uniform illumination of the LED lamp tube and even dark spots, the lost overlap range of lighting between adjacent light emitting diodes 4 is compensated mainly by increasing the number of the light emitting diodes 4 and by shortening the distance between adjacent light emitting diodes 4. That is, the overlap range of lighting between adjacent light emitting diodes 4 is increased by shortening the distance between adjacent light emitting diodes 4, in order to overcome the defects of non-uniform illumination of the LED lamp tube and even dark spots. However, as the number of the light emitting diodes 4 increases, the material and manufacturing cost of the LED lamp tube will also increase.

In addition, there is another solution where a light diffusion cover 1 with low luminous flux or a light diffusion cover 1 with a frosted surface is used. In this way, the luminous efficiency and luminous flux of the LED lamp tube will be reduced. However, the power consumption will increase in order to achieve the same output luminous flux.

### SUMMARY OF THE INVENTION

To solve the problems in the prior art, the present invention provides an LED lamp tube with uniform luminance.

The LED lamp tube with uniform luminance provided by the present invention comprises a lamp tube main body and a lamp holder connected to two ends of the lamp tube main body. A power supply is provided between the lamp tube main body and the lamp holder. The lamp tube main body comprises a light diffusion cover and a heat-dissipation casing which are engaged with each other together to form a lamp cavity. A substrate with light emitting diodes provided thereon is disposed on the heat-dissipation casing. The maximum distance from the light emitting diodes to the light diffusion cover is larger than 50% of the total height of the lamp tube main body.

As a further improvement of the present invention, the light diffusion cover and the heat-dissipation casing are engaged with each other to form a circle, and the maximum distance from the light emitting diodes to the light diffusion cover is larger than 50% of the diameter of the lamp tube main body.

As a further improvement of the present invention, the light diffusion cover and the heat-dissipation casing are engaged with each other to form a circle, and the maximum distance from the light emitting diodes to the light diffusion cover is larger than 60% of the diameter of the lamp tube main body.

As a further improvement of the present invention, the light diffusion cover and the heat-dissipation casing are engaged with each other to form a circle, and the maximum distance from the light emitting diodes to the light diffusion cover is larger than 70% of the diameter of the lamp tube main body.

As a further improvement of the present invention, the light diffusion cover and the heat-dissipation casing are engaged with each other to form a circle, and the maximum distance from the light emitting diodes to the light diffusion cover is larger than 75% of the diameter of the lamp tube main body.

As a further improvement of the present invention, the heat-dissipation casing comprises an arc-shaped outer plate and a substrate mounting plate that is a chord of the arc-shaped outer plate. The substrate is disposed on the substrate mounting plate with a threading chamber that is provided for a lead to pass through disposed between the substrate and the arc-shaped outer plate.

As a further improvement of the present invention, two sides of the light diffusion cover are provided with outward hooks turning up towards the outside in a radial direction. Two sides of the heat-dissipation casing are provided with inward hooks turning up towards the inside in the radial direction. The outward hooks and the inward hooks are clamped with each other.

As a further improvement of the present invention, the outward hooks comprise slope portions extending inward in the radial direction and hook portions turning up towards the outside in the radial direction.

As a further improvement of the present invention, the slope portions are parallel to light emitted by the light emitting diodes.

As a further improvement of the present invention, power supply mounting casings are provided between two ends of the lamp tube main body and the lamp holder. The power supply comprises a first split power supply and a second split power supply, which are disposed inside the two power supply mounting casings, respectively.

The present invention has the following advantages: by the above technical solution, the power supply is no longer provided inside the heat-dissipation casing but outside the heat-dissipation casing, a large accommodation space is not required to be reserved at the heat-dissipation casing to mount the power supply, so that the height of the substrate is reduced, the distance from the light emitting diodes to the light diffusion cover is further increased, the overlap area of lighting between adjacent light emitting diodes is increased, and thus the uniformity of lighting of the LED lamp tube is improved.

### BRIEF DESCRIPTION OF THE DRAWINGS

FIG. 1 is a schematic diagram of a cross-sectional structure of a conventional LED lamp tube in the prior art;

FIG. 2 is a schematic diagram of the relationship between a distance from light emitting diodes to a light diffusion cover and an overlap range of lighting between adjacent light emitting diodes;

FIG. 3 is a schematic diagram of the relationship between a distance from light emitting diodes to a light diffusion cover and an overlap range of lighting between adjacent light emitting diodes after the number of light emitting diodes is increased;

FIG. 4 is a structure diagram of an LED lamp tube with uniform luminance according to the present invention;

FIG. 5 is a schematic diagram of an internal structure of the LED lamp tube with uniform luminance according to the present invention;

FIG. 6 is a schematic diagram of a cross-sectional structure of the LED lamp tube with uniform luminance according to the present invention;

FIG. 7 is a schematic diagram of height markers of the cross-sectional structure of the LED lamp tube with uniform luminance according to the present invention;

FIG. 8 is a structure diagram when a conventional LED lamp tube in the prior art generates dark bands when turned on;

FIG. 9 is a structure diagram when the LED lamp tube with uniform luminance in the present invention does not generate dark bands when turned on; and

FIG. 10 is a schematic diagram of refraction generated on slop portions when the LED lamp tube with uniform luminance in the present invention is turned on.

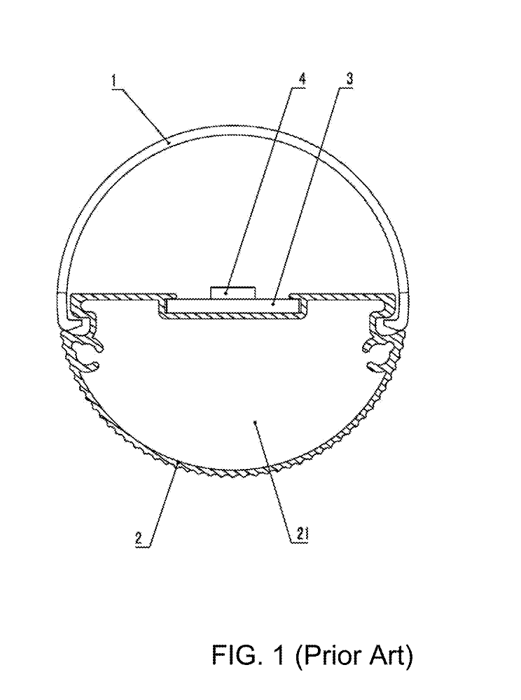

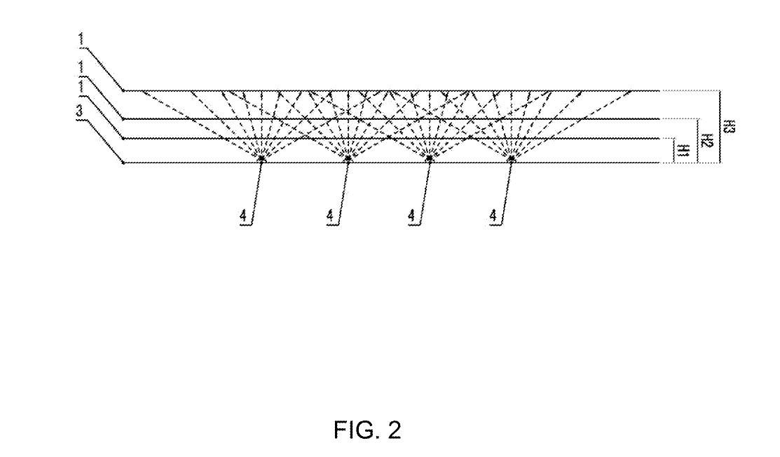

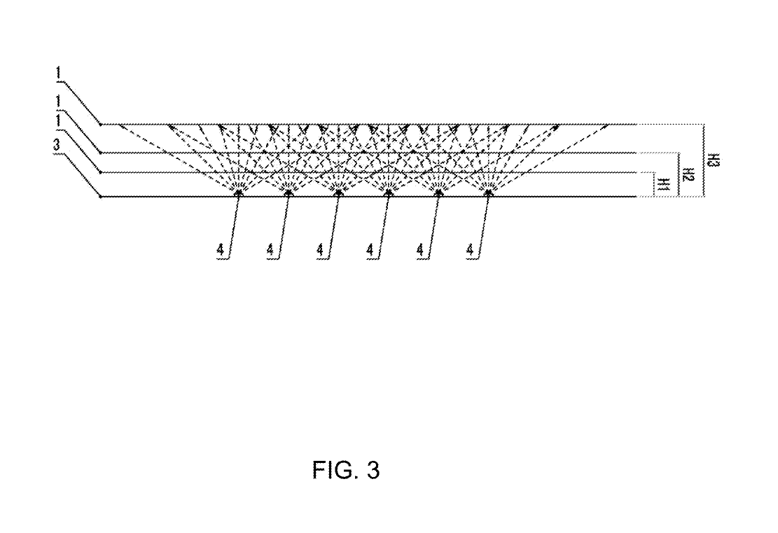

### DETAILED DESCRIPTION OF THE INVENTION

The present invention will be further described as below by specific implementation ways with reference to the drawings.

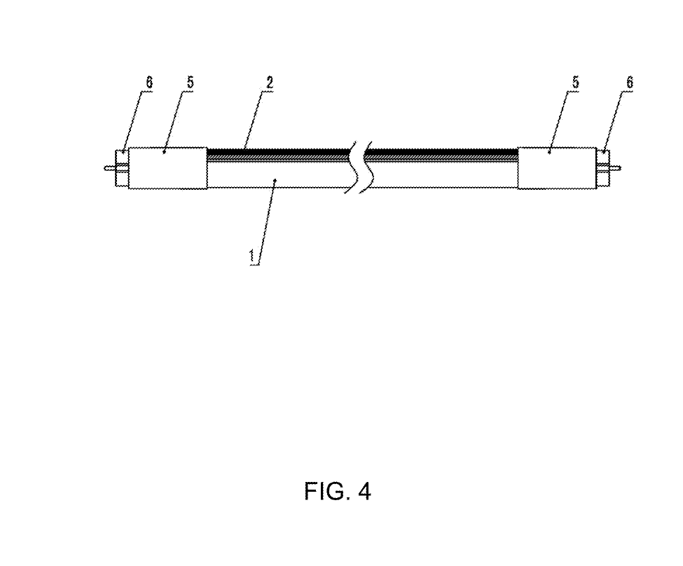

In FIG. 4 to FIG. 10:
1—Light diffusion cover;
11—Outward hook;
111—Slope portion;
112—Hook portion;
2—Heat-dissipation casing;
21—Threading chamber;
22—Inward hook;
23—Screw hole;
24—Substrate mounting plate
24; 25—Arc-shaped outer plate;
3—Substrate;
4—Light emitting diode;
5—Power supply;
51—First split power supply;
52—Second split power supply;
6—Lamp holder;
7—Power supply mounting casing; and,
8—Lamp cavity.

The dotted lines with arrows in FIG. 4 to FIG. 10 represent light emitted by the light emitting diodes 4.

As shown in FIG. 4 to FIG. 6, an LED lamp tube with uniform luminance is provided, comprising a lamp tube main body and a lamp holder 6 connected to two ends of the lamp tube main body. A power supply 5 is provided between the lamp tube main body and the lamp holder 6. The lamp tube main body comprises a light diffusion cover 1 and a heat-dissipation casing 2 which are engaged with each other together to form a lamp cavity 8. A substrate 2 with a plurality of light emitting diodes 4 provided thereon is disposed on the heat-dissipation casing 2. The light emitting diodes 4 are located inside the lamp cavity 8. The maximum distance from the light emitting diodes 4 to the light diffusion cover 1 is larger than 50% of the total height of the lamp tube main body. That is, the maximum distance from the light emitting diodes 4 to the light diffusion cover 1 is larger than 50% of the total cross-sectional height of the lamp tube main body. That is, the maximum distance from the light emitting diodes 4 to the light diffusion cover 1 is larger than 50% of the total height after the light diffusion cover 1 and the heat-dissipation casing 2 are engaged with each other, wherein the heat-dissipation casing 2 is preferably an aluminum heat-dissipation casing, the substrate 3 is preferably an aluminum heat radiating substrate, and the power supply 5 is a driving power supply.

As shown in FIG. 4 to FIG. 6, the light diffusion cover 1 and the heat-dissipation casing 2 are engaged with each other to form a circle. As a preferred solution, the maximum distance from the light emitting diodes 4 to the light diffusion cover 1 is larger than 40% of the diameter of the lamp tube main body.

As shown in FIG. 4 to FIG. 6, the light diffusion cover 1 and the heat-dissipation casing 2 are engaged with each other to form a circle. As a preferred solution, the maximum distance from the light emitting diodes 4 to the light diffusion cover 1 is larger than 50% of the diameter of the lamp tube main body.

As shown in FIG. 4 to FIG. 6, the light diffusion cover 1 and the heat-dissipation casing 2 are engaged with each other to form a circle. As a preferred solution, the maximum distance from the light emitting diodes 4 to the light diffusion cover 1 is larger than 60% of the diameter of the lamp tube main body.

As shown in FIG. 4 to FIG. 6, the light diffusion cover 1 and the heat-dissipation casing 2 are engaged with each other to form a circle. As a preferred solution, the maximum distance from the light emitting diodes 4 to the light diffusion cover 1 is larger than 70% of the diameter of the lamp tube main body.

As shown in FIG. 4 to FIG. 6, the light diffusion cover 1 and the heat-dissipation casing 2 are engaged with each other to form a circle. As a preferred solution, the maximum distance from the light emitting diodes 4 to the light diffusion cover 1 is larger than 75% of the diameter of the lamp tube main body.

As shown in FIG. 4 to FIG. 6, the light diffusion cover 1 and the heat-dissipation casing 2 are engaged with each other to form a circle. As a preferred solution, the maximum distance from the light emitting diodes 4 to the light diffusion cover 1 is larger than 80% of the diameter of the lamp tube main body.

As shown in FIG. 7, the diameter of the lamp tube main body is D, and the maximum distance from the light emitting diodes 4 to the light diffusion cover 1 is H.

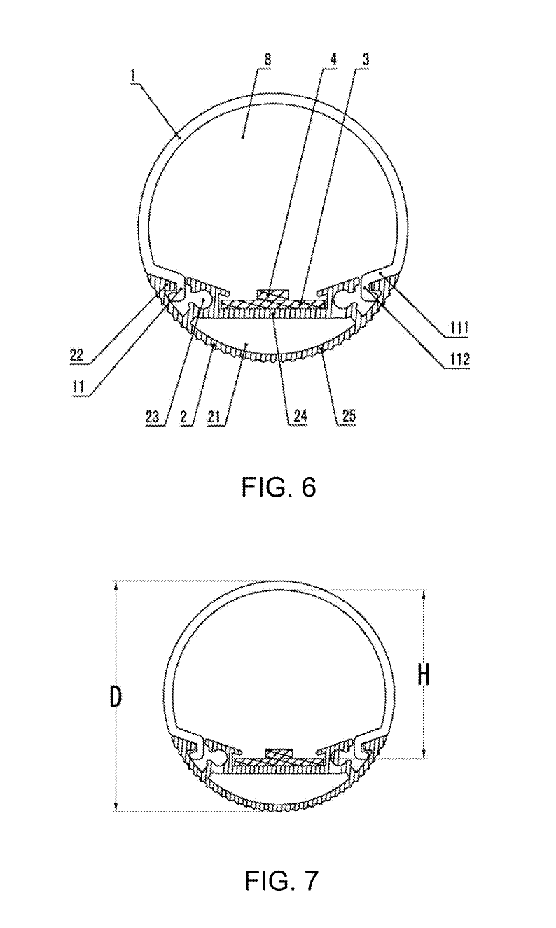

As shown in FIG. 6, the heat-dissipation casing 2 comprises an arc-shaped outer plate 25 and a substrate mounting plate 24 that is a chord of the arc-shaped outer plate 25. The substrate 3 is disposed on the substrate mounting plate 24 with a threading chamber 21 that is provided for a lead to pass through disposed between the substrate 3 and the arc-shaped outer plate 25, wherein the arc-shaped outer plate 25 is a minor arc, and the substrate mounting plate 24 is a chord of the minor arc. The threading chamber 21 is located between the minor arc and the chord. The light diffusion cover 1 is in a shape of major arc.

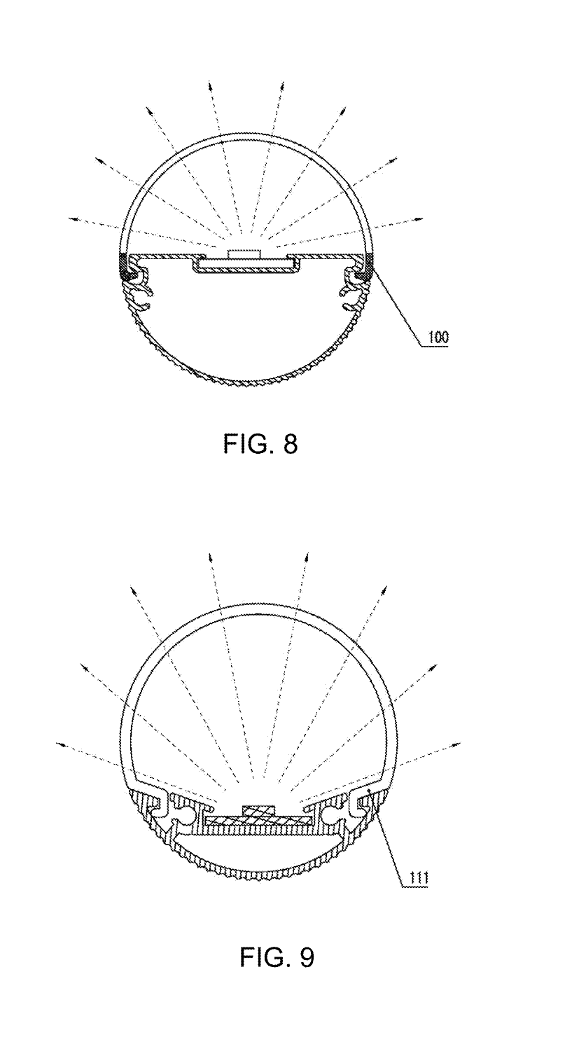

As shown FIG. 8, the light diffusion cover 1 and the heat-dissipation casing 2 in the conventional LED lamp tube in the prior art are externally buckled. That is, the heat-dissipation casing 2 is surrounded by the light diffusion cover 1. As light emitted by the light emitting diodes 4 is obstructed by the heat-dissipation casing 2, a dark band 100 will be generated at the buckling position of the light diffusion cover 1 and the heat-dissipation casing 2.

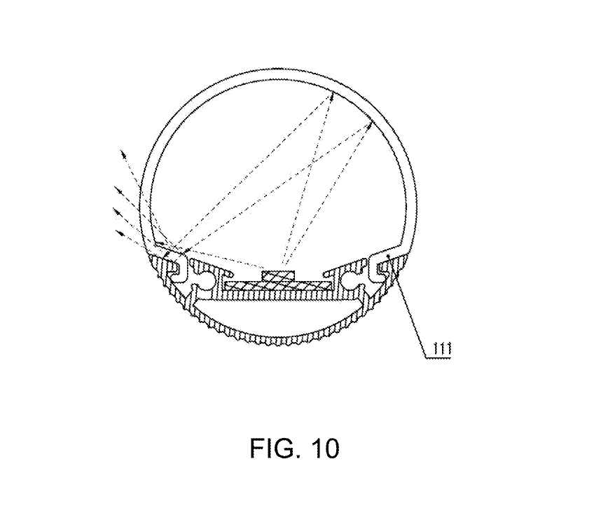

As shown in FIG. 6, FIG. 9 and FIG. 10, two sides of the light diffusion cover 1 are provided with outward hooks 11 turning up towards the outside in a radial direction. Two sides of the heat-dissipation casing 2 are provided with inward hooks 22 turning up towards the inside in the radial direction. The outward hooks 11 and the inward hooks 22 are clamped with each other. The distance from the outward hooks 11 to the center of the lamp tube main body is smaller than that from the inward hooks 22 to the center of the lamp tube main body, so the inverse clamping makes the heat-dissipation casing 2 surround the light diffusion cover 1. As light emitted by the light emitting diodes 4 will not be obstructed by the heat-dissipation casing 2, light may directly illuminate the light diffusion cover 1. Consequently, the generation of dark bands is avoided, and the uniformity of luminance of the LED lamp tube is improved.

As shown in FIG. 10, the outward hooks 11 comprise slope portions 111 extending inward in the radial direction and hook portions 112 turning up towards the outside in the radial direction. As the light diffusion cover 1 always has a certain degree of refraction, the refracted light may be refracted to the slope portions 111 partially, so that the brightness of the slope portions 111 is further enhanced, the generation of dark bands may be better avoided, and the uniformity of luminance of the LED lamp tube is improved.

As shown in FIG. 6, FIG. 9 and FIG. 10, the slope portions 111 are parallel to light emitted by the light emitting diodes 4. Therefore, light incoming to the slope portions 111 may be increased to the largest extent, so that the brightness of the slope portions 111 is further enhanced, the generation of dark bands may be better avoided, and the uniformity of luminance of the LED lamp tube is improved.

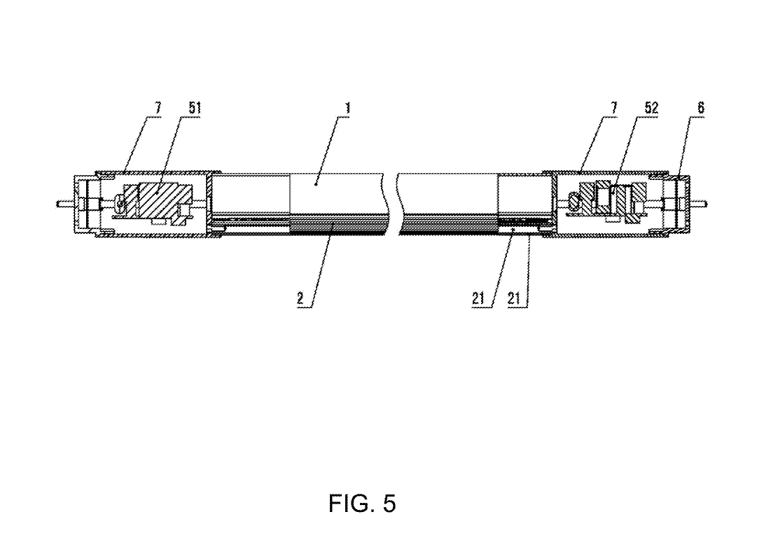

As shown in FIG. 4 and FIG. 5, power supply mounting casings 7 are provided between two ends of the lamp tube main body and the lamp holder 6. The power supply 5 comprises a first split power supply 51 and a second split power supply 52, which are disposed inside the two power supply mounting casings 7, respectively. That is, the power supply 5 is divided into two power supplies, which are separately disposed at two ends of the lamp tube main body, wherein the first split power supply 51 may be an EMI filtration and AC rectification circuit portion, while the second split power supply 52 may be a DC/DC conversion and control circuit portion. The first split power supply 51 and the second split power supply 52 are connected by a lead passing through the threading chamber 21. That is, the circuit of the power supply 5 is divided into two portions: one portion is the EMI filtration and AC rectification circuit portion, and the other portion is the DC/DC conversion and control circuit portion, so that the size of the power supply 5 may be reduced effectively. The size of the first split power supply 51 may also be symmetrical to the size of the second separation power supply 6. The control circuit may be made into a circuit board assembly, while a transformer and related output rectifier elements may form another circuit board assembly. The both circuit board assemblies may be welded together by mortises and tenons, or connected by flat cables or pins. The additionally arrangement of the filtering electrolytic capacitors at the output end of the power supply may enhance the efficiency of the power supply. There are relatively less elements in the EMI filtration and AC rectification circuit portion, while there are more elements in the DC/DC conversion and control circuit portion. An independent electrolytic capacitor may be additionally arranged inside the power supply mounting casing 7 of the first split power supply 51. This independent electrolytic capacitor may be connected by a copper wire on a light source board or by an additional electronic wire.

In another embodiment of the present invention, just one power supply 5 may be used, and the power supply 5 is disposed at one end of the lamp tube main body only.

A design of a terminal-type driving power supply is employed, where the power supply 5 is placed at two ends of the lamp tube main body, so that the heat of the driving power supply may be dissipated to the air via the power supply mounting casings 7. As the power supply is connected with the heat-dissipation casing 2 only at ends, so there is little influence on the heating of the heat-dissipation casing 2. When this solution is compared with the design solution where the driving power supply is provided inside the cavity of the heat-dissipation casing in the conventional solution, the heat of the light emitting diodes 4 may be uniformly dissipated outside through the heat-dissipation casing 2, not both the heat dissipation of the power supply and the heat dissipation of the light emitting diodes 4 depend on the heat-dissipation casing 2. The LED lamp tube, with a power supply provided inside the cavity of the aluminum heat-dissipation casing, has unbalanced heat generation at two ends thereof. One end with the driving power supply has heat higher than the end without the driving power supply, as a result, due to a higher temperature, the LED lamp beads at the end with the driving power supply (the heating of the power supply and the heating of the LED lamp beads are mutually influenced) have quicker light attenuation than the other end.

In the LED lamp tube with uniform luminance disclosed by the present invention, the power supply 5 is no longer provided inside the heat-dissipation casing 2 but outside the heat-dissipation casing 2, a large accommodation space is not required to be reserved at the heat-dissipation casing 2 to mount the power supply 5, so that the height of the substrate 3 is reduced, the distance from the light emitting diodes 4 to the light diffusion cover 1 is further increased, the overlap area of lighting between adjacent light emitting diodes 4 is increased, and thus the uniformity of lighting of the LED lamp tube is improved.

With the advantages of no light spots and dark bands, high luminous efficacy, low cost and energy saving, the LED lamp tube with uniform luminance disclosed by the present invention is designed with minimal LED lamp beads (i.e., light emitting diodes 4), a light diffusion cover 1 with high light transmittance and a rational structure. The uniform output of target luminous flux is realized. Therefore, the LED lamp tube with uniform luminance disclosed by the present invention is an LED lamp tube with high luminous efficacy, uniform luminance and cost competitiveness.

The LED lamp tube with uniform luminance disclosed by the present invention may be applicable to LED lamp tubes with a circular cross-section, LED lamp tubes with an irregular cross-section, T8, T10 or LED lamp tubes with a closed cross-section, or all-plastic tubes without any aluminum heat-dissipation casing.

The above is just further detailed description of the present invention by specific preferred embodiments. It should not be considered that the specific embodiments of the present invention are limited thereto. A person of ordinary skill in the art may make various simple derivations or replacements without departing from the idea of the present invention, and all these derivations or replacements should be regarded as falling into the protection scope of the present invention.

What is claimed is:

1. An LED lamp tube with uniform luminance, comprising a lamp tube main body and a lamp holder connected to two ends of the lamp tube main body, a power supply being provided between the lamp tube main body and the lamp holder, the lamp tube main body comprising a light diffusion cover and a heat-dissipation casing engaged with each other to form a lamp cavity, a substrate with light emitting diodes provided thereon being disposed on the heat-dissipation casing, the maximum distance from the light emitting diodes to the light diffusion cover being larger than 50% of the total height of the lamp tube main body.

2. The LED lamp tube with uniform luminance according to claim 1, wherein the light diffusion cover and the heat-dissipation casing are engaged with each other to form a circle, and the maximum distance from the light emitting diodes to the light diffusion cover is larger than 50% of the diameter of the lamp tube main body.

3. The LED lamp tube with uniform luminance according to claim 1, wherein the light diffusion cover and the heat-dissipation casing are engaged with each other to form a circle, and the maximum distance from the light emitting diodes to the light diffusion cover is larger than 60% of the diameter of the lamp tube main body.

4. The LED lamp tube with uniform luminance according to claim 1, wherein the light diffusion cover and the heat-dissipation casing are engaged with each other to form a circle, and the maximum distance from the light emitting diodes to the light diffusion cover is larger than 70% of the diameter of the lamp tube main body.

5. The LED lamp tube with uniform luminance according to claim 1, wherein the light diffusion cover and the heat-dissipation casing are engaged with each other to form a circle, and the maximum distance from the light emitting diodes to the light diffusion cover is larger than 75% of the diameter of the lamp tube main body.

6. The LED lamp tube with uniform luminance according to claim 1, wherein the heat-dissipation casing comprises an arc-shaped outer plate and a substrate mounting plate that is a chord of the arc-shaped outer plate, and the substrate is disposed on the substrate mounting plate with a threading chamber that is provided for a lead to pass through disposed between the substrate and the arc-shaped outer plate.

7. The LED lamp tube with uniform luminance according to claim 1, wherein two sides of the light diffusion cover are provided with outward hooks turning up towards the outside in a radial direction, two sides of the heat-dissipation casing being provided with inward hooks turning up towards the inside in the radial direction, the outward hooks and the inward hooks being clamped with each other.

8. The LED lamp tube with uniform luminance according to claim 7, wherein the outward hooks comprise slope portions extending inward in the radial direction and hook portions turning up towards the outside in the radial direction.

9. The LED lamp tube with uniform luminance according to claim 8, wherein the slope portions are parallel to light emitted by the light emitting diodes.

10. The LED lamp tube with uniform luminance according to claim 1, wherein power supply mounting casings are provided between two ends of the lamp tube main body and the lamp holder, the power supply comprising a first split power supply and a second split power supply, which are disposed inside the two power supply mounting casings, respectively.
